(19) United States
(12) Patent Application Publication
(10) Pub. No.: US 2014/0374645 A1
(43) Pub. Date: Dec. 25, 2014

(54) MAGNETIC RECORDING MEDIUM AND COATING COMPOSITION FOR MAGNETIC RECORDING MEDIUM

(71) Applicant: FUJIFILM Corporation, Tokyo (JP)

(72) Inventors: Wataru KIKUCHI, Minami-ashigara-shi (JP); Toshihide AOSHIMA, Minami-ashigara-shi (JP); Yuushi KANEKO, Minami-ashigara-shi (JP); Kazutoshi KATAYAMA, Minami-ashigara-shi (JP); Katsuhiko MEGURO, Minami-ashigara-shi (JP)

(73) Assignee: FUJIFILM CORPORATION, Tokyo (JP)

(21) Appl. No.: 14/311,894

(22) Filed: Jun. 23, 2014

(30) Foreign Application Priority Data
Jun. 24, 2013 (JP) 2013-131974
Jun. 23, 2014 (JP) 2014-128527

(51) Int. Cl. G11B 5/70; H01F 1/42

(52) U.S. Cl. CPC G11B 5/7013; H01F 1/42
USPC 252/62.54

(57) ABSTRACT

An aspect of the present invention relates to a magnetic recording medium comprising a magnetic layer comprising ferromagnetic powder and binder on a nonmagnetic support, wherein an average particle size of the ferromagnetic powder is equal to or less than 50 nm, the magnetic layer further comprises a compound, and the compound comprises at least one polyalkyleneimine chain and at least one polyester chain, with a proportion in the compound accounted for by the polyalkyleneimine chain being less than 5.0 weight percent and a number average molecular weight of the polyalkyleneimine chain ranging from 300 to 3,000.

### CROSS-REFERENCE TO RELATED APPLICATIONS

This application claims priority under 35 U.S.C 119 to Japanese Patent Application No. 2013-131974 filed on Jun. 24, 2013 and Japanese Patent Application No. 2014-128527 filed on Jun. 23, 2014. Each of the above applications is hereby expressly incorporated by reference, in its entirety.

### BACKGROUND OF THE INVENTION

1. Field of the Invention

The present invention relates to a magnetic recording medium and a coating composition for a magnetic recording medium.

2. Discussion of the Background

In recent years, means of rapidly transmitting information have undergone considerable development, making it possible to transmit huge amounts of information in the form of images and data. As these data transmission technologies have improved, ever higher density recording has been demanded of the magnetic recording and reproduction devices and magnetic recording media that are used to record, reproduce, and store information. To achieve good electromagnetic characteristics in the high-density recording region, it is effective to employ ferromagnetic powder of small particle size, to increase the dispersion of ferromagnetic powder of small particle size, and to enhance the smoothness of the magnetic layer surface to reduce spacing loss.

The use of a dispersing agent (see Japanese Unexamined Patent Publication (KOKAI) Heisei No. 5-177123 or English language family member U.S. Pat. No. 4,645,611, which are expressly incorporated herein by reference in their entirety), the incorporation of structural units to enhance dispersion in binder (see Japanese Unexamined Patent Publication (KOKAI) No. 2011-216149, which is expressly incorporated herein by reference in its entirety), and the like have been proposed as means of enhancing the dispersion of ferromagnetic powder.

### SUMMARY OF THE INVENTION

As described in the above publications, various means of enhancing dispersion of ferromagnetic powder have been proposed. However, the demand for higher recording density in magnetic recording media has continued to intensify. Under such conditions, there has been a trend of reducing the particle size beyond that of conventional ferromagnetic powder. As a result, there has also been need for a means of further increasing the dispersion of ferromagnetic powder of small particle size.

An aspect of the present invention provides for a means of enhancing the dispersion of ferromagnetic powder of small particle size for even higher density recording.

The present inventors conducted extensive research. As a result, they made the following discoveries.

In recent years, for ever higher recording densities, there has been a need to use small ferromagnetic powder with an average particle size of equal to or less than 50 nm. Additionally, Japanese Unexamined Patent Publication (KOKAI) Heisei No. 5-177123 set forth above proposes enhancing the dispersion of magnetic material by means of a dispersing agent derived from polyethyleneimine. However, based on study by the present inventors, it is difficult to enhance dispersion of ferromagnetic powder of the above-stated size with the use of the dispersing agent described in Japanese Unexamined Patent Publication (KOKAI) Heisei No. 5-177123.

As a result of conducting further extensive research, the present inventors discovered that by means of a compound, comprising at least one polyester chain and at least one polyalkyleneimine chain, the polyalkyleneimine chain having a number average molecular weight ranging from 300 to 3,000, with the proportion in the compound accounted for by the polyalkyleneimine chain being less than 5.0 weight percent, it was possible to enhance the dispersion of ferromagnetic powder having an average particle size of equal to or less than 50 nm. This point will be further described below. The following has been presumed by the present inventors and does not limit the present invention in any way.

In the above compound, the polyester chain is thought to play the role of inhibiting aggregation between particles of ferromagnetic powder as a steric repulsion chain in the coating composition for forming a magnetic layer. Additionally, the polyalkyleneimine chain is presumed to function as a moiety that can adsorb to the surface of particles of ferromagnetic powder. Thus, the present inventors have presumed that in the coating composition for forming a magnetic layer, the above compound can adsorb to the surface of particles of ferromagnetic powder by means of the polyalkyleneimine chain. The polyester chain can effectively spread out in the coating composition, preventing particles of ferromagnetic powder from aggregating. More specifically, in the above compound, the fact that the polyalkyleneimine chain that is thought to function as an adsorbing moiety is more compact than the dispersing agent described in Japanese Unexamined Patent Publication (KOKAI) Heisei No. 5-177123 is thought by the present inventors to be why an adequate dispersion-enhancing effect can be achieved on ferromagnetic powder with an average particle size of equal to or less than 50 nm.

The present inventors also discovered to their surprise that the use of the above compound as a magnetic layer component could enhance the running durability of the magnetic recording medium. Although the reason for this is not entirely clear, the present inventors presume one cause to be the above compound imparting flexibility to the magnetic layer.

Japanese Unexamined Patent Publication (KOKAI) No. 2011-216149 proposes imparting a graft chain structure to the binder to inhibit aggregation between particles. However, the facts that dispersion of ferromagnetic powder with an average particle size of equal to or less than 50 nm can be enhanced and the running durability of the magnetic recording medium can also be improved have been newly discovered by the present inventors and cannot be anticipated from the description in Japanese Unexamined Patent Publication (KOKAI) No. 2011-216149.

An aspect of the present invention was devised based on the above discoveries.

An aspect of the present invention relates to a magnetic recording medium comprising a magnetic layer comprising ferromagnetic powder and binder on a nonmagnetic support, wherein:

an average particle size of the ferromagnetic powder is equal to or less than 50 nm;

the magnetic layer further comprises a compound; and

the compound comprises at least one polyalkyleneimine chain and at least one polyester chain, with a proportion in the compound accounted for by the polyalkyleneimine chain being less than 5.0 weight percent and a number average molecular weight of the polyalkyleneimine chain ranging from 300 to 3,000.

A further aspect of the present invention relates to a coating composition, which is a coating composition for a magnetic recording medium and comprises:

ferromagnetic powder having an average particle size of equal to or less than 50 nm;

a compound comprising at least one polyalkyleneimine chain and at least one polyester chain, with a proportion in the compound accounted for by the polyalkyleneimine chain being less than 5.0 weight percent and a number average molecular weight of the polyalkyleneimine chain ranging from 300 to 3,000; and

a solvent.

In an embodiment, the polyester chain comprises at least one polyester chain selected from the group consisting of a polyester chain denoted by formula 1 and a polyester chain denoted by formula 2:

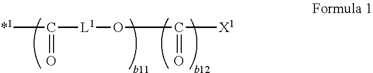

wherein, in formula 1, L¹ denotes a divalent linking group, b11 denotes an integer of equal to or greater than 2, b12 denotes 0 or 1, X¹ denotes a hydrogen atom or a monovalent substituent, and the polyester chain denoted by formula 1 is bonded to a nitrogen atom present in an alkyleneimine chain contained in the polyalkyleneimine chain at a bond position denoted by *¹;

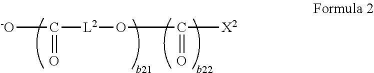

wherein, in formula 2, L² denotes a divalent linking group, b21 denotes an integer of equal to or greater than 2, b22 denotes 0 or 1, X² denotes a hydrogen atom or a monovalent substituent, and an oxygen anion O⁻ in the polyester chain denoted by formula 2 forms a salt crosslinking group with N⁺ present in an alkyleneimine chain contained in the polyalkyleneimine chain.

In an embodiment, the polyester chain comprises at least one polyester chain selected from the group consisting of:

the polyester chain denoted by formula 1, wherein X¹ denotes a monovalent substituent selected from the group consisting of an alkyl group, haloalkyl group, alkoxy group, polyalkyleneoxyalkyl group, and aryl group; and

the polyester chain denoted by formula 2, wherein X² denotes a monovalent substituent selected from the group consisting of an alkyl group, haloalkyl group, alkoxy group, and aryl group.

In an embodiment, the compound is a reaction product of polyalkyleneimine having a number average molecular weight ranging from 300 to 3,000 and polyester having a number average molecular weight ranging from 200 to 100,000.

In an embodiment, the polyalkyleneimine is a polymer of identical or different alkyleneimines having 2 to 4 carbon atoms.

In an embodiment, the magnetic layer or the coating composition comprises 0.5 weight part to 50 weight parts of the compound per 100 weight parts of the ferromagnetic powder.

In an embodiment, the ferromagnetic powder is hexagonal ferrite powder having an average plate diameter ranging from 10 nm to 50 nm.

In an embodiment, the ferromagnetic powder is ferromagnetic metal powder having an average major axis length ranging from 10 nm to 50 nm.

In an embodiment, the coating composition further comprises binder.

In an embodiment, the coating composition further comprises a curing agent.

In an embodiment, the solvent is a ketone solvent.

An aspect of the present invention can enhance the dispersion of ferromagnetic powder with an average particle size of equal to or less than 50 nm in a magnetic layer. An aspect of the present invention can provide a magnetic recording medium that affords good electromagnetic characteristics and high running durability.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

### Magnetic Recording Medium

An aspect of the present invention relates to a magnetic recording medium comprising a magnetic layer comprising ferromagnetic powder and binder on a nonmagnetic support. The average particle size of the ferromagnetic powder is equal to or less than 50 nm, the magnetic layer further comprises a compound (also referred to as a “polyalkyleneimine derivative”, hereinafter), and the compound comprises at least one polyalkyleneimine chain and at least one polyester chain, with a proportion in the compound accounted for by the polyalkyleneimine chain being less than 5.0 weight percent and a number average molecular weight of the polyalkyleneimine chain ranging from 300 to 3,000.

The above magnetic recording medium will be described in greater detail below. In the present invention, the numbers preceding and succeeding the word “to” denote the minimum value and maximum value, respectively, of a range which includes these values.

### Polyalkyleneimine Derivative

The polyalkyleneimine derivative is a compound comprising at least one polyalkyleneimine chain with a number average molecular weight ranging from 300 to 3,000 and a polyester chain. The proportion in the above compound accounted for by the polyalkyleneimine chain is less than 5.0 weight percent.

<Polyalkyleneimine Chain>

### (Number Average Molecular Weight)

In the present invention, the number average molecular weight of the polyalkyleneimine chain contained in the polyalkyleneimine derivative refers to a value, obtained by gel permeation chromatography (GPC) using standard polystyrene conversion, for the polyalkyleneimine obtained by hydrolyzing the polyalkyleneimine derivative. The value thus obtained is the same as or similar to the value obtained by gel permeation chromatography (GPC) using standard polystyrene conversion for the polyalkyleneimine used to synthesize the polyalkyleneimine derivative. Accordingly, the number average molecular weight obtained for the polyalkyleneimine used to synthesize the polyalkyleneimine derivative can be adopted as the number average molecular weight of the polyalkyleneimine chain contained in the polyalkyleneimine derivative. Reference can be made to Examples set forth further below for the conditions for measuring the number average molecular weight of the polyalkyleneimine chain. Polyalkyleneimine is a polymer that can be obtained by ring-opening polymerization of alkyleneimine. In the present invention and in the present Specification, the term “polymer” is used with a meaning that includes homopolymers containing repeating units of identical structure, and copolymers containing repeating units of two or more different structures.

Further, hydrolysis of the polyalkyleneimine derivative can be conducted by any of the various methods commonly employed as ester hydrolysis methods. For details regarding such methods, for example, reference can be to the description of hydrolysis methods given in “Experimental Chemistry Lecture 14 Synthesis of Organic Compounds II—Alcohols•Amines (5th Ed.),” (compiled by the Chemical Society of Japan, Maruzen Publishing, released August 2005), pp. 95 to 98; and to the description of hydrolysis methods given in “Experimental Chemistry Lecture 16 Synthesis of Organic Compounds IV—Carboxylic Acids•Amino Acids•Peptides (5th Ed.),” (compiled by the Chemical Society of Japan, Maruzen Publishing, released March 2005), pp. 10 to 15, which are expressly incorporated herein by reference in their entirety.

Polyalkyleneimine can be separated from the hydrolysis product thus obtained by known separation means such as liquid chromatography, and the number average molecular weight thereof can be obtained.

The number average molecular weight of the polyalkyleneimine chain contained in the polyalkyleneimine derivative ranges from 300 to 3,000. The present inventors presume that keeping the number average molecular weight of the polyalkyleneimine chain to within the above range permits the polyalkyleneimine derivative to effectively adsorb to the surface of the particles of ferromagnetic powder. From the perspective of adsorption to the surface of the particles of ferromagnetic powder, the number average molecular weight of the polyalkyleneimine chain is desirably equal to or higher than 500. From the same perspective, it is desirably equal to or lower than 2,000.

(Proportion in the Polyalkyleneimine Derivative Accounted for by the Polyalkyleneimine Chain)

As set forth above, the polyalkyleneimine chain contained in the polyalkyleneimine derivative is thought by the present inventors to function as a moiety that adsorbs to the surface of the particles of ferromagnetic powder. By means of a polyalkyleneimine derivative in which the proportion accounted for by the polyalkyleneimine chain (also referred to as the “polyalkyleneimine chain ratio” hereinafter) is less than 5.0 weight percent, it is possible to enhance the dispersion of ferromagnetic powder with an average particle size of equal to or less than 50 nm. To further enhance the dispersion of ferromagnetic powder having the above average particle size, it is desirable for the polyalkyleneimine chain ratio to be equal to or less than 4.9 weight percent, preferably equal to or less than 4.8 weight percent, more preferably equal to or less than 4.5 weight percent, still more preferably equal to or less than 4.0 weight percent, and yet still more preferably, equal to or less than 3.0 weight percent. Additionally, from the perspective of enhancing the dispersion of ferromagnetic powder having an average particle size of equal to or less than 50 nm, it is desirable for the polyalkyleneimine chain ratio to be equal to or greater than 0.2 weight percent, preferably equal to or greater than 0.3 weight percent, and more preferably, equal to or greater than 0.5 weight percent.

The above proportion accounted for by the polyalkyleneimine chain can be controlled, for example, by means of the mixing ratio of polyalkyleneimine and polyester used during synthesis.

The proportion in the polyalkyleneimine derivative accounted for by the polyalkyleneimine chain can be calculated from the results of analysis by nuclear magnetic resonance (NMR)—more specifically, ¹H-NMR and ¹³C-NMR—and by elemental analysis by known methods. Since the value thus calculated is identical to or similar to the theoretical value obtained from the compounding ratio of the synthesis starting materials of the polyalkyleneimine derivative, the theoretical value obtained from the compounding ratio can be adopted as the proportion in the polyalkyleneimine derivative accounted for by the polyalkyleneimine chain.

(Structure of the Polyalkyleneimine Chain)

The polyalkyleneimine chain is a polymerization structure comprising two or more identical or different alkyleneimine chains. Examples of the alkyleneimine chains that are contained are the alkyleneimine chain denoted by formula A and the alkyleneimine chain denoted by formula B below. Among the alkyleneimine chains denoted by the formulas given below, the alkyleneimine chain denoted by formula A can contain a site for bonding to a polyester chain. The alkyleneimine chain denoted by formula B can bond with a polyester chain by means of a salt crosslinking group (details of which are given further below). The polyalkyleneimine derivative can have a structure in which one or more polyester chains are bonded to a polyalkyleneimine chain by incorporating one or more such alkyleneimine chains. The polyalkyleneimine chains can be comprised of just linear structures, or have branched tertiary amine structures. From the perspective of further enhancing dispersion, it is desirable for branched structures to be present on the polyalkyleneimine chains. Examples of polyalkyleneimine chains having branched structures are those that bond to an adjacent alkyleneimine chain through *¹ in formula A below and those that bond to an adjacent alkyleneimine chain through *² in formula B below.

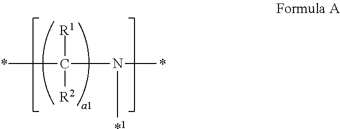

In formula A, each of R¹ and R² independently denotes a hydrogen atom or an alkyl group; a1 denotes an integer of equal to or greater than 2; and *¹ denotes the site of a bond with a polyester chain, an adjacent alkyleneimine chain, a hydrogen atom, or a substituent.

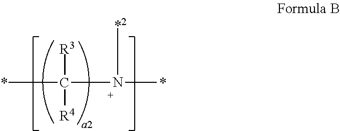

In formula B, each of R³ and R⁴ independently denotes a hydrogen atom or an alkyl group, and a2 denotes an integer of equal to or greater than 2. The alkyleneimine chain denoted by formula B bonds to a polyester chain having an anionic group by N⁺ in formula B and the anionic group contained in the polyester chain forming a salt crosslinking group.

The * in formulas A and B, and the *² in formula B, each independently denotes the position of a bond with an adjacent alkyleneimine chain, a hydrogen atom or a substituent.

Formulas A and B will be described in greater detail below. In the present invention, unless specifically stated otherwise, the groups that are described can be substituted or unsubstituted. When a given group comprises a substituent, examples of the substituent are alkyl groups (such as alkyl groups having 1 to 6 carbon atoms), hydroxyl groups, alkoxy groups (such as alkoxy groups having 1 to 6 carbon atoms), halogen atoms (such as fluorine atoms, chlorine atoms, and bromine atoms), cyano groups, amino groups, nitro groups, acyl groups, and carboxyl groups. For a group having a substituent, the “number of carbon atoms” means the number of carbon atoms of the portion not comprising the substituent.

Each of R¹ and R² in formula A, and each of R³ and R⁴ in formula B, independently denotes a hydrogen atom or an alkyl group. Examples of the alkyl groups are alkyl groups having 1 to 6 carbon atoms, desirably alkyl groups having 1 to 3 carbon atoms, preferably methyl or ethyl groups, and more preferably, methyl groups. Combinations of R¹ and R² in formula A include an embodiment where one denotes a hydrogen atom and the other denotes an alkyl group, an embodiment where both denote alkyl groups (identical or different alkyl groups), and desirably, an embodiment where both denote hydrogen atoms. The above matters are also applied to R³ and R⁴ in formula B.

The structure with the fewest carbon atoms constituting the ring in an alkyleneimine is ethyleneimine. The number of carbon atoms on the main chain of the alkyleneimine chain (ethyleneimine chain) obtained by opening the ring of ethyleneimine is 2. Accordingly, the lower limit of a1 in formula A and of a2 in formula B is 2. That is, each of a1 in formula A and a2 in formula B independently denotes an integer of equal to or greater than 2. From the perspective of adsorption to the surface of particles of ferromagnetic powder, each of a1 in formula A and a2 in formula B is independently desirably equal to or less than 10, preferably equal to or less than 6, more preferably equal to or less than 4, still more preferably 2 or 3, and yet still more preferably, 2.

The bond between the alkyleneimine chain denoted by formula A or the alkyleneimine chain denoted by formula B and a polyester chain will be described further below.

Each of the alkyleneimine chains set forth above bonds to an adjacent alkyleneimine chain, a hydrogen atom, or a substituent at the positions denoted by * in the various formulas above. An example of a substituent is a monovalent substituent such as an alkyl group (such as an alkyl group with 1 to 6 carbon atoms), but this is not a limitation. A polyester chain can also be bonded as a substituent.

<Polyester Chain>

### (Structure of Polyester Chain)

The polyalkyleneimine derivative comprises at least one polyester chain together with the polyalkyleneimine chain described above. In an embodiment, the polyester chain can bond with the alkyleneimine chain denoted by formula A by means of the nitrogen atom N contained in formula A and a carbonyl bond —(C═O)—, forming —N—(C═O)— at *¹ in formula A. In another embodiment, the alkyleneimine chain denoted by formula B and a polyester chain can form a salt crosslinking group by means of the nitrogen cation N⁺ in formula B and an anionic group present in the polyester chain. An example of the salt crosslinking group is one formed by an oxygen anion O⁻ contained in the polyester chain and the N⁺ in formula B. However, this is not a limitation.

The polyester chain denoted by formula 1 below is an example of a polyester chain bonding to the nitrogen atom N contained in formula A by means of a carbonyl bond —(C═O)— to the alkyleneimine chain denoted by formula A. The polyester chain denoted by formula 1 below can bond to the alkyleneimine chain denoted by formula A at the bond position denoted by *¹ by the formation of —N—(C═O)— by the nitrogen atom contained in the alkyleneimine chain and the carbonyl group —(C═O)— contained in the polyester chain.

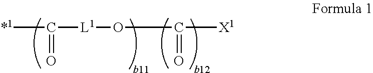

The polyester chain denoted by formula 2 below is an example of a polyester chain that can bond to the alkyleneimine chain denoted by formula B by means of the N⁺ in formula B and an anionic group contained in the polyester chain forming a salt crosslinking group. In the polyester group denoted by formula 2 below, the oxygen anion O⁻ and the N⁺ in formula B can form a salt crosslinking group.

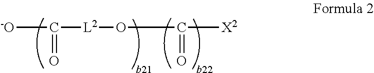

Each of L¹ in formula 1 and L² in formula 2 independently denotes a divalent linking group. A desirable example of a divalent linking group is an alkylene group having 3 to 30 carbon atoms. As set forth above, the number of carbon atoms in an alkylene group refers to the portion (main chain portion) excluding the substituent when the alkylene group comprises a substituent.

Each of b11 in formula 1 and b21 in formula 2 independently denotes an integer of equal to or greater than 2; for example, an integer of equal to or less than 200. The number of repeating lactone units given in Examples further below corresponds to b11 in formula 1 or b21 in formula 2.

Each of b12 in formula 1 and b22 in formula 2 independently denotes 0 or 1.

Each of X¹ in formula 1 and X² in formula 2 independently denotes a hydrogen atom or a monovalent substituent. Examples of monovalent substituents are monovalent substituents selected from the group consisting of alkyl groups, haloalkyl groups (such as fluoroalkyl groups), alkoxy groups, polyalkyleneoxyalkyl groups, and aryl groups.

The alkyl group may be substituted or unsubstituted. An alkyl group substituted with at least one hydroxyl group (a hydroxyalkyl group) and an alkyl group substituted with at least one halogen atom are desirable as a substituted alkyl group. An alkyl group in which all the hydrogen atoms bonded to carbon atoms have been substituted with halogen atoms (a haloalkyl group) is also desirable. Examples of halogen atoms include fluorine, chlorine and bromine atoms. An alkyl group having 1 to 30 carbon atoms is preferred, and an alkyl group having 1 to 10 carbon atoms is of greater preference. The alkyl group can be linear, have a branched chain, or be cyclic. The same applies to a haloalkyl group.

Specific examples of substituted and unsubstituted alkyl groups and haloalkyl groups are: a methyl group, ethyl group, propyl group, butyl group, pentyl group, hexyl group, heptyl group, octyl group, nonyl group, decyl group, undecyl group, dodecyl group, tridecyl group, pentadecyl group, hexadecyl group, heptadecyl group, octadecyl group, eicosyl group, isopropyl group, isobutyl group, isopentyl group, 2-ethylhexyl group, tert-octyl group, 2-hexyldecyl group, cyclohexyl group, cyclopentyl group, cyclohexylmethyl group, octylcyclohexyl group, 2-norbornyl group, 2,2,4-trimethylpentyl group, acetylmethyl group, acetylethyl group, hydroxymethyl group, hydroxyethyl group, hydroxylpropyl group, hydroxybutyl group, hydroxypentyl group, hydroxyhexyl group, hydroxyheptyl group, hydroxyoctyl group, hydroxynonyl group, hydroxydecyl group, chloromethyl group, dichloromethyl group, trichloromethyl group, bromomethyl group, 1,1,1,3,3,3-hexafluoroisopropyl group, heptafluoropropyl group, pentadecafluoroheptyl group, nonadecafluorononyl group, hydroxyundecyl group, hydroxydodecyl group, hydroxypentadecyl group, hydroxyheptadecyl group, and hydroxyoctadecyl group.

Examples of alkoxy groups are a methoxy group, ethoxy group, propyloxy group, hexyloxy group, methoxyethoxy group, methoxyethoxyethoxy group, and methoxyethoxyethoxymethyl group.

Polyalkyleneoxyalkyl groups are monovalent substituents denoted by R¹⁰ (OR¹¹)ₙ(O)ₘ—. R¹⁰ denotes an alkyl group, R¹¹ denotes an alkylene group, n denotes an integer of equal to or greater than 2, and m denotes 0 or 1.

The alkyl group denoted by R¹⁰ is as described for the alkyl groups denoted by X¹ and X². The details of the alkylene group denoted by R¹¹ are as follows. The above description of the alkyl groups denoted by X¹ and X² can be applied to these alkylene groups by reading alkylenes with one fewer hydrogen atom for the former (for example, by reading “methylene group” for “methyl group”). n denotes an integer of equal to or greater than 2; for example, an integer of equal to or less than 10, desirably equal to or less than 5.

The aryl group can be substituted and can be a condensed ring. It is preferably an aryl group with 6 to 24 carbon atoms, such as a phenyl group, a 4-methylphenyl group, 4-phenylbenzoic acid, a 3-cyanophenyl group, a 2-chlorophenyl group, or a 2-naphthyl group.

The polyester chains denoted by formulas 1 and 2 above can be structures derived from polyesters obtained by known polyester synthesis methods. Lactone ring-opening polymerization is an example of a polyester synthesis method. Examples of lactones are ε-caprolactone, δ-caprolactone, β-propiolactone, γ-butyrolactone, δ-valerolactone, γ-valerolactone, enantolactone, β-butyrolactone, γ-hexanolactone, γ-octanolactone, δ-hexanolactone, δ-octanolactone, δ-dodecanolactone, α-methyl-γ-butyrolactone, and lactide. The lactide can be of either the L or D form. In polyester synthesis, it is possible to use one type of lactone, or two types or more of differing structure. ε-lactone, lactides, and δ-valerolactone are desirable as lactones from the perspectives of reactivity and availability. However, there is no limitation thereto. Any lactone yielding polyester by means of ring-opening polymerization will do.

Carboxylic acid, alcohols, and the like can be employed as nucleophilic reagents in lactone ring-opening polymerization. Carboxylic acid is desirable. One type of carboxylic acid or a mixture of two or more types can be employed.

Carboxylic acid can be denoted as R¹²(C═O)OH. The moiety R¹²(C═O)— can be present as the moiety X¹—(C═O)— in the polyester chain denoted by formula 1. The same applies to the moiety X²—(C═O)— on the polyester chain denoted by formula 2.

R¹² can be acyclic in structure (linear or branched in structure), or can be cyclic in structure. The details of R¹² are as set forth for X¹ in formula 1 and X² in formula 2 above.

Examples of carboxylic acids are acetic acid, propionic acid, butyric acid, valeric acid, n-hexanoic acid, n-octanoic acid, n-decanoic acid, n-dodecanoic acid, palmitic acid, 2-ethylhexanoic acid, cyclohexanoic acid, stearic acid, glycolic acid, lactic acid, 3-hydroxypropionic acid, 4-hydroxydodecanoic acid, 5-hydroxydodecanoic acid, cyclohexylacetic acid, adamantanecarboxylic acid, adamantaneacetic acid, ricinoleic acid, 12-hydroxydodecanoic acid, 12-hydroxystearic acid, 2,2-bis(hydroxymethyl)butyric acid, [2-(2-methoxyethoxy)ethoxy)]acetic acid, monochloroacetic acid, dichloroacetic acid, bromoacetic acid, nonafluorovaleric acid, heptadecafluorononanoic acid, 3,5,5-trimethylhexanoic acid, acetyl acetic acid, 4-oxovaleric acid, benzoic acid, 4-phenylbenzoic acid, and 2-naphthoic acid. Among these, carboxylic acids with 1 to 20 total carbon atoms per molecule (including the number of carbon atoms of the substituents when present) are desirable. Carboxylic acids in which R¹² is a polyalkyleneoxyalkyl group (polyalkyleneoxyalkylcarboxylic acids), carboxylic acids in which R¹² is a haloalkyl group (haloalkylcarboxylic acids), linear aliphatic carboxylic acids having 6 to 20 carbon atoms, and carboxylic acids comprising at least one hydroxyl group with 1 to 20 carbon atoms are preferred.

However, the above polyester chain is not limited to a structure derived from polyester obtained by lactone ring-opening polymerization. It can have a structure derived from polyester obtained by a known polyester synthesis method such as polycondensation of a polyvalent carboxylic acid and polyhydric alcohol or polycondensation of a hydroxycarboxylic acid.

(Number Average Molecular Weight of Polyester Chain)

From the perspective of enhancing dispersion of the ferromagnetic powder, the number average molecular weight of the polyester chain is desirably equal to or greater than 200, preferably equal to or greater than 400, and more preferably, equal to or greater than 500. From the same perspective, the number average molecular weight of the polyester chain is desirably equal to or less than 100,000, preferably equal to or less than 50,000. As set forth above, the polyester chain is thought to play the role of inhibiting aggregation between particles of ferromagnetic powder as a steric repulsion chain in the coating composition for forming a magnetic layer. A polyester chain having the above number average molecular weight is presumed to play the above role well. The number average molecular weight of the polyester chain refers to a value of polyester obtained by hydrolyzing the polyalkyleneimine derivative, that is measured by gel permeation chromatography (GPC) using standard polystyrene conversion. The value thus measured is the same as or similar to the value of polyester that has been used to synthesize the polyalkyleneimine derivative, measured by gel permeation chromatography (GPC) using standard polystyrene conversion. Accordingly, the number average molecular weight that is obtained for the polyester used to synthesize the polyalkyleneimine derivative can be adopted as the number average molecular weight of the polyester chain contained in the polyalkyleneimine derivative. Reference can be made to the measurement conditions for the number average molecular weight of the polyester in Examples set forth further below for the measurement conditions for the number average molecular weight of the polyester chain.

<Weight Average Molecular Weight of Polyalkyleneimine Derivative>

With regard to the molecular weight of the polyalkyleneimine derivative, the weight average molecular weight is, for example, equal to or greater than 1,000, and for example, equal to or less than 80,000. From the perspective of running durability, it is desirably equal to or greater than 1,500, preferably equal to or greater than 2,000, and more preferably, equal to or greater than 3,000. From the perspective of enhancing dispersion, it is desirably equal to or less than 60,000, preferably equal to or less than 40,000, more preferably equal to or less than 35,000, and still more preferably, equal to or less than 34,000. In the present invention, the weight average molecular weight of the polyalkyleneimine derivative refers to a value measured by gel permeation chromatography (GPC) using standard polystyrene conversion. Reference can be made to Examples further below for the measurement conditions.

<Synthesis Methods>

So long as the polyalkyleneimine derivative comprises the polyalkyleneimine chain with a number average molecular weight ranging from 300 to 3,000 in the above-stated proportion in addition to the polyester chain, the synthesis method is not specifically limited. An example of a desirable embodiment of synthesis method is the method of reacting polyalkyleneimine (referred to as “component A-1”, hereinafter) with polyester (referred to as “component A-2”, hereinafter).

Component A-1 is desirably polyalkyleneimine having a number average molecular weight ranging from 300 to 3,000. The details of the measurement method, desirable range, and the like of the number average molecular weight of component A-1 are the same as those set forth for the polyalkyleneimine chain above.

Polyalkyleneimine is a polymer that can be obtained by alkyleneimine ring-opening polymerization, as set forth above. The details of the structure of polyalkyleneimine are as set forth for the polyalkyleneimine chain above.

The same one, two, or more types of different alkyleneimines can be employed as the alkyleneimines yielding polyalkyleneimine by ring-opening polymerization. Details regarding the number of carbon atoms of the alkyleneimine are as set forth above for a1, a2, and a3 in formulas A, B, and C. Alkyleneimines with 2 to 4 carbon atoms are desirably employed. Alkyleneimines with 2 or 3 carbon atoms are preferred. An alkyleneimine with two carbon atoms, that is, ethyleneimine, is of greater preference. The number of carbon atoms in an alkyleneimine refers to the number of carbon atoms in the ring structure.

The polyalkyleneimine employed as component A-1 can be synthesized by known methods or obtained as a commercial product.

Component A-2 is polyester. A polyester chain can be imparted to the polyalkyleneimine derivative by means of component A-2. Details regarding the measurement method, desirable range, and the like of the number average molecular weight of component A-2 are as set forth above for the polyester chain.

Component A-2 can react with the polyalkyleneimine by having one or more functional groups capable of reacting with the polyalkyleneimine. As set forth above, in the polyalkyleneimine derivative thus formed, the polyester chain desirably bonds with the alkyleneimine chain constituting the polyalkyleneimine chain by means of —N—(C═O)— or a salt crosslinking group. To impart such a bond, the functional group of the polyester is desirably in the form of a monovalent acidic group. In this context, the term “acidic group” refers to a group that is capable of dissociating into an anion by releasing H⁺ in water in a solvent containing water (aqueous solvent). Such groups can form bonds with polyalkyleneimine chains or form salt crosslinking groups. Specific examples are a carboxyl group, sulfonic acid group, phosphoric acid group, and salts thereof. A carboxyl group and carboxyl salt group are desirable. In this context, the form of the salt of a carboxyl group (—COOH) means a carboxyl salt group in which the M in —COOM denotes a cation such as an alkali metal ion. The same applies to the forms of salts of other acidic groups. From the perspective of introducing a polyester chain capable of effectively functioning as a steric repulsion chain, the number of the functional groups contained in component A-2 is desirably 1. From the same perspective, the functional group is desirably incorporated as a terminal functional group in component A-2.

The acidic group has been specified above with regard to water or an aqueous solvent. However, the polyalkyleneimine derivative is not limited to those that can be employed in a water-based (in this context, the term “based” is used to mean “containing”) solvent. It can desirably be employed in non-water-based solvents. Nor is the solvent contained in the coating composition for a magnetic recording medium that is described further below and contains the polyalkyleneimine derivative limited to water-based solvents. It can be a non-water-based solvent, and is desirably a non-water-based solvent.

Details of the structure of the polyester are as set forth for the polyester chain above. The above-described polyester can be synthesized by known methods or can be obtained as a commercial product. For example, polyester having a terminal functional group in the form of a carboxyl group can be obtained by the method of conducting lactone ring-opening polymerization in the presence of a nucleophilic reagent such as carboxylic acid. With regard to the polyester synthesis conditions, known techniques can be applied without limitation. The polyester having a carboxyl group as a terminal functional group can be bonded with the alkyleneimine chain denoted by formula A by means of —N—(C═O)—. It can also be bonded with the alkyleneimine denoted by formula B by means of the above-described salt crosslinking group. Details such as specific examples of carboxylic acids and the like are as set forth above.

The reaction of above-described components A-1 and A-2 can be conducted by known polymerization methods such as solution polymerization and the like. For example, it can be conducted by stirring and mixing components A-1 and A-2, optionally in the presence of an organic solvent. The reaction can progress without a solvent. For example, a reaction solution containing components A-1 and A-2 can be heated (to a heating temperature of 50° C. to 200° C., for example) while being stirred in air or in a nitrogen atmosphere, or heated (to a heating temperature of 40° C. to 150° C., for example) while adding a catalyst such as an organic tin compound such as monobutyltin oxide, an ammonium salt such as trimethylammonium bromide, a tertiary amine such as benzyldimethylamine, or a quaternary ammonium salt, to conduct the reaction. Examples of organic solvents are ethyl acetate, chloroform, tetrahydrofuran, methyl ethyl ketone, acetone, acetonitrile, and toluene.

Those given further below in Examples are specific examples of the polyalkyleneimine derivative thus obtained.

In another aspect, a compound containing at least one polyalkyleneimine chain and at least one polyester chain—wherein the proportion in the compound accounted for by the polyalkyleneimine chain is less than 5.0 weight percent, the weight average molecular weight is equal to or less than 40,000, desirably equal to or less than 35,000, and preferably, equal to or less than 34,000—can be employed as a magnetic layer component. Reference can be made to the description above relating to the polyalkyleneimine derivative for details about the compound.

The magnetic recording medium of an aspect of the present invention comprises the above-described polyalkyleneimine derivative in a magnetic layer. From the perspective of enhancing dispersion of the ferromagnetic powder with the above average particles size by means of the polyalkyleneimine derivative, the content of the polyalkyleneimine derivative in the magnetic layer is desirably equal to or greater than 0.5 weight part, preferably equal to or greater than 1 weight part, per 100 weight parts of ferromagnetic powder. Additionally, from the perspective of high density recording, the content of components other than ferromagnetic powder is desirably kept relatively low to increase the fill rate of ferromagnetic powder. For this reason, the content of polyalkyleneimine derivative in the magnetic layer is desirably equal to or less than 50 weight parts, preferably equal to or less than 40 weight parts, per 100 weight parts of ferromagnetic powder.

Ferromagnetic Powder

The ferromagnetic powder contained in the magnetic layer together with the polyalkyleneimine derivative will be described next.

The ferromagnetic powder has an average particle size of equal to or less than 50 nm. Ferromagnetic powder with an average particle size of equal to or less than 50 nm is suitable for the high density recording demanded in recent years, but enhancing the dispersion thereof may be difficult. An aspect of the present invention can enhance the dispersion of ferromagnetic powder of the above-stated size by means of the above polyalkyleneimine derivative. From the perspective of magnetization stability, the average particle size is desirably equal to or greater than 10 nm.

The average particle size of the ferromagnetic powder is a value that is measured by the following method with a transmission electron microscope.

Ferromagnetic powder is photographed at a magnification of 100,000-fold with a transmission electron microscope, and the photograph is printed on print paper at a total magnification of 500,000-fold to obtain a photograph of the particles constituting the ferromagnetic powder. A target particle is selected from the photograph of particles that has been obtained, the contour of the particle is traced with a digitizer, and the size of the (primary) particle is measured. The term “primary particle” refers to an unaggregated, independent particle.

The above measurement is conducted on 500 randomly extracted particles. The arithmetic average of the particle size of the 500 particles obtained in this manner is adopted as the average particle size of the ferromagnetic powder. A Model H-9000 transmission electron microscope made by Hitachi can be employed as the above transmission electron microscope, for example. The particle size can be measured with known image analysis software, such as KS-400 image analysis software from Carl Zeiss.

In the present invention, the average particle size of the powder is the average particle size as obtained by the above method. The average particle size indicated in Examples further below was obtained using a Model H-9000 transmission electron microscope made by Hitachi and KS-400 image analysis software made by Carl Zeiss.

The method described in paragraph 0015 of Japanese Unexamined Patent Publication (KOKAI) No. 2011-048878, which is expressly incorporated herein by reference in its entirety, for example, can be employed as the method of collecting sample powder such as ferromagnetic powder from a magnetic layer for particle size measurement.

In the present invention, the size of the particles constituting powder such as ferromagnetic powder (referred to as the “particle size”, hereinafter) is denoted as follows based on the shape of the particles observed in the above particle photograph:

(1) When acicular, spindle-shaped, or columnar (with the height being greater than the maximum diameter of the bottom surface) in shape, the particle size is denoted as the length of the major axis constituting the particle, that is, the major axis length.
(2) When platelike or columnar (with the thickness or height being smaller than the maximum diameter of the plate surface or bottom surface) in shape, the particle size is denoted as the maximum diameter of the plate surface or bottom surface.
(3) When spherical, polyhedral, of unspecific shape, or the like, and the major axis constituting the particle cannot be specified from the shape, the particle size is denoted as the diameter of an equivalent circle. The term “diameter of an equivalent circle” means that obtained by the circle projection method.

The “average acicular ratio” of a powder refers to the arithmetic average of values obtained for the above 500 particles by measuring the length of the minor axis, that is the minor axis length, of the particles measured above, and calculating the value of the (major axis length/minor axis length) of each particle. The term “minor axis length” refers to, in the case of the particle size definition of (1), the length of the minor axis constituting the particle; in the case of (2), the thickness or height, and in the case of (3), since the major axis and minor axis cannot be distinguished, (major axis length/minor axis length) is deemed to be 1 for the sake of convenience.

When the particle has a specific shape, such as in the particle size definition of (1) above, the average particle size is the average major axis length. In the case of (2), the average particle size is the average plate diameter, with the average plate ratio being the arithmetic average of (maximum diameter/thickness or height). For the definition of (3), the average particle size is the average diameter (also called the average particle diameter).

Hexagonal ferrite powder is a specific example of desirable ferromagnetic powder. From the perspectives of achieving higher density recording and magnetization stability, the average particle size (average plate diameter) of hexagonal ferrite powder desirably ranges from 10 nm to 50 nm, preferably 20 nm to 50 nm. Reference can be made to Japanese Unexamined Patent Publication (KOKAI) No. 2011-216149, paragraphs 0134 to 0136, for details on hexagonal ferrite powder.

Ferromagnetic metal powder is also a specific example of desirable ferromagnetic powder. From the perspectives of achieving higher density recording and magnetization stability, the average particle size (average major axis length) of ferromagnetic metal powder desirably ranges from 10 nm to 50 nm, preferably 20 nm to 50 nm. Reference can be made to Japanese Unexamined Patent Publication (KOKAI) No. 2011-216149, paragraphs 0137 to 0141, for details on ferromagnetic metal powder.

Magnetic Layer

The magnetic recording medium of an aspect of the present invention is a particulate magnetic recording medium with a magnetic layer containing binder together with the above-described polyalkyleneimine derivative and ferromagnetic powder. The binder employed can be in the form of polyurethane resin, polyester resin, polyamide resin, vinyl chloride resin, styrene, acrylonitrile, methyl methacrylate, and other copolymerized acrylic resins; nitrocellulose and other cellulose resins; epoxy resin; phenoxy resin; polyvinyl acetal, polyvinyl butyral, and other polyvinyl alkyrals; these resins can be employed singly or two or more resins can be mixed for use. Of these, the polyurethane resins, acrylic resins, cellulose resins, and vinyl chloride resins are desirable. These resins can also be employed as binders in the nonmagnetic layer, described further below. Reference can be made to Japanese Unexamined Patent Publication (KOKAI) No. 2010-24113, which is expressly incorporated herein by reference in its entirety, paragraphs 0028 to 0031, with regard to the binders. It is also possible to employ a curing agent with these resins. Polyisocyanates are suitable as curing agents. Reference can be made to Japanese Unexamined Patent Publication (KOKAI) No. 2011-216149, paragraphs 0124 and 0125, for details regarding polyisocyanates. The curing agent can be employed, for example, by adding a quantity of 0 to 80 weight parts, desirably 50 weight parts to 80 weight parts from the perspective of enhancing the coating strength, per 100 weight parts of binder to the coating liquid for forming the magnetic layer.

Additives can be added to the magnetic layer as needed. Examples of additives are abrasives, lubricants, dispersing agents, dispersing adjuvants, antifungal agents, antistatic agents, oxidation-inhibiting agents, and carbon black. The additives can be used by suitably selecting, for example, commercial products based on the properties desired. In the magnetic recording medium of an aspect of the present invention, the polyalkyleneimine derivative can function as a dispersing agent.

The magnetic layer set forth above can be provided directly or through one or more layers such as a nonmagnetic layer, on a nonmagnetic support. Details regarding the nonmagnetic layer and the nonmagnetic support will be described further below.

Nonmagnetic Layer

Details of the nonmagnetic layer will be described next. In the magnetic recording medium of an aspect of the present invention, a nonmagnetic layer containing nonmagnetic powder and binder can be formed between the nonmagnetic support and the magnetic layer. Either inorganic substances or organic substances can be employed as the nonmagnetic powder in the nonmagnetic layer. Carbon black can also be employed. Examples of inorganic substances are metals, metal oxides, metal carbonates, metal sulfates, metal nitrides, metal carbides, and metal sulfides. These nonmagnetic powders are available as commercial products and can be manufactured by known methods. Reference can be made to Japanese Unexamined Patent Publication (KOKAI) No. 2011-216149, paragraphs 0146 to 0150, for details in this regard.

The binders, lubricants, dispersing agents, additives, solvents, dispersion methods, and the like of the magnetic layer can be applied to the nonmagnetic layer. In particular, techniques that are known with regard to the magnetic layer can be applied to the quantity and type of binder and the quantities and types of additives and dispersing agents that are added. It is also possible to add carbon black and organic powders to the nonmagnetic layer. In that regard, reference can be made to Japanese Unexamined Patent Publication (KOKAI) No. 2010-24113, paragraphs 0040 to 0042, for example.

Nonmagnetic Support

Details of the nonmagnetic support will be described next. Examples of nonmagnetic supports are known supports such as biaxially stretched polyethylene terephthalate, polyethylene naphthalate, polyamide, polyamide-imide, and aromatic polyamide. Of these, polyethylene terephthalate, polyethylene naphthalate, and polyamide are desirable.

These supports can be subjected to corona discharge, plasma treatment, adhesion-enhancing treatment, and heat treatment in advance. The surface roughness of a nonmagnetic support that can be employed is desirably a center average roughness Ra of 3 nm to 10 nm at a cutoff value of 0.25 mm.

Layer Structure

With regard to the thickness of the nonmagnetic support and each layer in the magnetic recording medium, the thickness of the nonmagnetic support is desirably 3 μm to 80 μm. The thickness of the magnetic layer can be optimized for the magnetization saturation and head gap length of the magnetic head employed, the bandwidth of the recording signal, and the like, but is generally 10 nm to 150 nm, desirably 20 nm to 120 nm, preferably 30 nm to 100 nm. It suffices for the magnetic layer to be comprised of at least one layer, and it can be separated into two or more layers of differing magnetic characteristics. A structure relating to a known multilayer magnetic layer can be applied.

The thickness of the nonmagnetic layer is, for example, 0.1 μm to 3.0 μm, desirably 0.1 μm to 2.0 μm, and preferably 0.1 μm to 1.5 μm. The nonmagnetic layer in the present invention includes an essentially nonmagnetic layer containing trace quantities of ferromagnetic powder, for example, either as impurities or intentionally, in addition to the nonmagnetic powder. The essentially nonmagnetic layer means a layer exhibiting a residual magnetic flux density of equal to or less than 10 mT, a coercive force of equal to or less than 7.96 kA/m (100 Oe), or a residual magnetic flux density of equal to or less than 10 mT and a coercive force of equal to or less than 7.96 kA/m (100 Oe). The nonmagnetic desirably has no residual magnetic flux density or coercive force.

Backcoat Layer

In the magnetic recording medium of an aspect of the present invention, a backcoat layer can be provided on the opposite surface of the nonmagnetic support from the surface on which the magnetic layer is present. The backcoat layer desirably contains carbon black and inorganic powder. The formula of the magnetic layer or nonmagnetic layer can be applied to the binder and various additives for forming the backcoat layer. The backcoat layer is desirably equal to or less than 0.9 μm, preferably 0.1 to 0.7 μm in thickness.

Manufacturing Process

The coating composition for a magnetic recording medium of an aspect of the present invention that is set forth further below can be employed as is, or a solvent, additives, and the like can be optionally added to it for use as the coating liquid (coating composition) for forming a magnetic layer.

The process of manufacturing coating liquids for forming the magnetic layer, nonmagnetic layer, and backcoat layer normally comprises at least a kneading step, dispersing step, and a mixing step, provided as needed before and/or after these steps. Each of these steps can be divided into two or more stages. All of the starting materials employed in an aspect of the present invention, such as the ferromagnetic powder, nonmagnetic powder, binder, carbon black, abrasives, antistatic agents, lubricants, and solvents can be added either at the start of, or part way through, any step. Any of the starting materials can be divided up and added in two or more steps. For example, polyurethane can be divided up and added in the kneading step, dispersing step, and in a kneading step after the dispersing step for viscosity adjustment. To manufacture the magnetic recording medium of an aspect of the present invention, conventionally known manufacturing techniques can be employed. A device with powerful kneading strength such as an open kneader, continuous kneader, pressure kneader, extruder, or the like is desirably employed in the kneading step. These kneading treatments are described in Japanese Unexamined Patent Publication (KOKAI) Heisei Nos. 1-106338 and 1-79274, which are expressly incorporated herein by reference in their entirety. Glass beads or some other beads can be employed to disperse the magnetic layer coating liquid, nonmagnetic layer coating liquid, or backcoat layer coating liquid. Dispersion beads of high specific gravity in the form of zirconia beads, titanium beads, or steel balls are suitable as such dispersion beads. These dispersion beads can be employed by optimizing their particle diameters and fill rates. A known dispersing apparatus can be employed. Reference can be made to Japanese Unexamined Patent Publication (KOKAI) No. 2010-24113, paragraphs 0051 to 0057, for details on methods of manufacturing the magnetic recording medium.

In an aspect of the present invention, the dispersion of ferromagnetic powder with an average particle size of equal to or less than 50 nm can be enhanced in the magnetic layer. Accordingly, an aspect of the present invention can provide a magnetic recording medium for use in high-density recording that affords good electromagnetic characteristics. The magnetic recording medium with a magnetic layer containing the above-described polyalkyleneimine derivative can also exhibit high running durability.

### Coating Composition for Magnetic Recording Medium

An aspect of the present invention relates to a coating composition for a magnetic recording medium comprising ferromagnetic powder with an average particle size of equal to or less than 50 nm, the above-described polyalkyleneimine derivative, and a solvent (also referred to hereinafter as the “coating composition”).

Details regarding the ferromagnetic powder and polyalkyleneimine derivative contained in the coating composition of an aspect of the present invention are as set forth above.

Examples of the solvent are organic solvents that are generally employed to manufacture particulate magnetic recording media. Specific examples are: acetone, methyl ethyl ketone, methyl isobutyl ketone, diisobutyl ketone, cyclohexanone, isophorone, tetrahydrofuran, and other ketones; methanol, ethanol, propanol, butanol, isobutyl alcohol, isopropyl alcohol, methylcyclohexanol, and other alcohols; methyl acetate, butyl acetate, isobutyl acetate, isopropyl acetate, ethyl lactate, glycol acetate, and other esters; glycol dimethyl ether, glycol monoethyl ether, dioxane, and other glycol ethers; benzene, toluene, xylene, cresol, chlorobenzene, and other aromatic hydrocarbons; methylene chloride, ethylene chloride, carbon tetrachloride, chloroform, ethylene chlorohydrin, dichlorobenzene, and other chlorinated hydrocarbons; N,N-dimethylformamide; and hexane. They can be employed in any ratio. Of these, the use of organic solvents containing ketones (ketone organic solvents) is desirable from the perspectives of the solubility of the binders that are commonly employed in magnetic recording media and adsorption of the binder to the surface of the particles of ferromagnetic powder.

The above organic solvent does not have to be 100 percent pure, and may contain impurities, such as foreign matter, unreacted material, byproducts, decomposition products, oxides, and moisture, in addition to the primary component. These impurities desirably constitute equal to or less than 30 weight percent, preferably equal to or less than 10 weight percent. Somewhat strong polarity is desirable for enhancing dispersion; it is desirable for the solvent composition to comprise equal to or greater than 50 weight percent of a solvent with a dielectric constant of equal to or greater than 15. A dissolution parameter of 8 to 11 is desirable. The quantity of solvent in the coating composition of an aspect of the present invention is not specifically limited, and can be set to the range as in a common coating liquid for forming a magnetic layer in a particulate magnetic recording medium.

The polyalkyleneimine derivative that is contained in the coating composition of an aspect of the present invention as set forth above can prevent the aggregation of ferromagnetic powder having the above stated average particle size in the coating composition by incorporating the polyester chain capable of functioning as a steric repulsion chain in the coating composition, with the proportion in the polyalkyleneimine chain capable of functioning as an adsorption moiety on particles of ferromagnetic powder being less than 5 weight percent. Accordingly, the coating composition can be employed as is, or can be employed in the form of a coating composition for forming a magnetic layer that is obtained by adding a solvent and known additives, to obtain a magnetic recording medium that is capable of exhibiting good electromagnetic characteristics and exhibiting high surface smoothness by enhancing dispersion of the ferromagnetic powder with an average particle size of equal to or less than 50 nm. The magnetic recording medium having a magnetic layer formed of the above coating composition can also afford high running durability.

### EXAMPLES

The present invention will be described in detail below based on Examples. However, the present invention is not limited to embodiments shown in Examples. The terms “parts” and “percent” given in Examples are weight parts and weight percent unless otherwise stated.

The acid numbers and amine numbers given below were determined by the electric potential method (solvent: tetrahydrofuran/water=100/10 (volumetric ratio), titrant: 0.01 N (0.01 mol/l) sodium hydroxide aqueous solution (acid number), 0.01 N (0.0 l/mol/l) hydrochloric acid (amine number)).

The number average molecular weights and weight average molecular weights given below were measured by GPC method and rendered as polystyrene conversion values.

The conditions under which the average molecular weight of the polyester, polyalkyleneimine, and polyalkyleneimine derivative were measured were as follows.

(Measurement Conditions for Average Molecular Weight of Polyester)

Measurement apparatus: HLC-8220GPC (made by Tosoh)

Columns: TSKgel Super HZ 2000/TSKgel Super HZ 4000/TSKgel Super HZ-H (made by Tosoh)

Eluent: Tetrahydrofuran (THF)

Flow rate: 035 mL/min

Column temperature: 40° C.

Detector: Differential refractive (RI) detector

(Measurement conditions for average molecular weight of polyalkyleneimine, average molecular weight of polyalkyleneimine derivative)

Measurement apparatus: HLC-8320GPC (made by Tosoh)

Columns: Three columns of TSKgel Super AWM-H (made by Tosoh)

Eluent: N-methyl-2-pyrrolidone (10 mM lithium bromide added as additive)

Flow rate: 0.35 mL/min

Column temperature: 40° C.

Detector: RI

The number average molecular weight of the polyalkyleneimine chain can also be measured by the following method.

The polyalkyleneimine derivatives that were synthesized in the synthesis examples described further below were hydrolyzed by an ester hydrolysis method such as the acid hydrolysis method described in Experimental Chemistry Lecture 16 Synthesis of Organic Compounds IV—Carboxylic Acids•Amino acids•Peptides (5th Ed.), (compiled by the Chemical Society of Japan, Maruzen Publishing, released March 2005), p. 11. It is also possible to separate the polyalkyleneimine by liquid chromatography from the hydrolysis product obtained and to adopt the number average molecular weight measured under the above measurement conditions as the number average molecular weight of the polyalkyleneimine chain contained in the polyalkyleneimine derivative.

### Synthesis Example 1

### Synthesis of Polyester (i-1)

In a 500 mL three-necked flask were mixed 12.6 g of carboxylic acid in the form of n-octanoic acid (made by Wako Pure Chemical Industries, Ltd.), 100 g of lactone in the form of ε-caprolactone (Placcel M made by Daicel Industrial Chemicals, Ltd.), and 2.2 g of catalyst in the form of monobutyltin oxide (made by Wako Pure Chemical Industries, Ltd.) (C₄H₉Sn(O)OH) and the mixture was heated for one hour at 160° C. A 100 g quantity of ε-caprolactone was added dropwise over 5 hours and the mixture was stirred for another two hours. Subsequently, the mixture was cooled to room temperature, yielding polyester (i-1).

The synthesis scheme is indicated below.

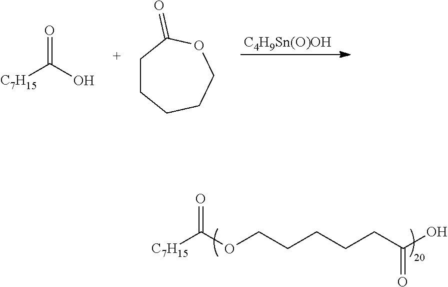

### Synthesis Examples 2 to 12, 15 to 20

With the exceptions that the carboxylic acid and lactone were changed as indicated in Table 1 and the quantity of carboxylic acid charged was varied, polyesters (i-2) to (i-12) and (i-15) to (i-20) were obtained in the same manner as in Synthesis Example 1.

### Synthesis Example 13

In a 500 mL three-necked flask were mixed 17.31 g of carboxylic acid in the form of n-octanoic acid (made by Wako Pure Chemical Industries, Ltd.), lactones in the form of 143.82 g of ε-caprolactone (Placcel M made by Daicel Industrial Chemicals, Ltd.) and 77.82 g of L-lactide (made by Tokyo Chemical Industry Co., Ltd.), and 6.12 g of catalyst in the form of monobutyltin oxide (made by Wako Pure Chemical Industries, Ltd.) (C₄H₉Sn(O)OH), and the mixture was heated for eight hours at 160° C. Subsequently, the mixture was cooled to room temperature, yielding polyester (i-13).

### Synthesis Example 14

In a 500 mL three-necked flask were mixed 17.31 g of carboxylic acid in the form of n-octanoic acid (made by Wako Pure Chemical Industries, Ltd.), lactones in the form of 181.59 g of ε-caprolactone (Placed M made by Daicel Industrial Chemicals, Ltd.) and 61.65 g of L-lactide (made by Tokyo Chemical Industry Co., Ltd.), and 6.12 g of catalyst in the form of monobutyltin oxide (made by Wako Pure Chemical Industries, Ltd.) (C₄H₉Sn(O)OH), and the mixture was heated for eight hours at 160° C. Subsequently, the mixture was cooled to room temperature, yielding polyester (i-14).

The number average molecular weight and weight average molecular weight of the polyesters obtained in Synthesis Examples 1 to 20 are given in Table 1 below. Table 1 also gives the number of repeating lactone units calculated based on the starting material charging ratios for each polyester.

TABLE 1

| | | | Amount of | | Weight | Number | |
|---|---|---|---|---|---|---|---|
| | | | carboxylic | | average | average | Number of |
| | | | acid | | molecular | molecular | repeating |
| | Polyester | Carboxylic acid | charged (g) | Lactone | weight | weight | lactone units |
| Synthesis | (i-1) | n-octanoic acid | 12.6 | ε-caprolactone | 9,000 | 7,500 | 20 |
| Example 1 | | | | | | | |
| Synthesis | (i-2) | n-octanoic acid | 16.8 | ε-caprolactone | 7,000 | 5,800 | 15 |
| Example 2 | | | | | | | |
| Synthesis | (i-3) | n-octanoic acid | 3.3 | L-lactide | 22,000 | 18,000 | 60 |
| Example 3 | | | | | | | |
| Synthesis | (i-4) | palmitic acid | 4.5 | ε-caprolactone | 38,000 | 31,000 | 100 |
| Example 4 | | | | | | | |
| Synthesis | (i-5) | palmitic acid | 12.8 | δ-valerolactone | 16,000 | 13,000 | 40 |
| Example 5 | | | | | | | |
| Synthesis | (i-6) | stearic acid | 99.7 | ε-caprolactone | 2,500 | 2,000 | 5 |
| Example 6 | | | | | | | |
| Synthesis | (i-7) | glycolic acid | 13.3 | ε-caprolactone | 4,800 | 4,000 | 10 |
| Example 7 | | | | | | | |
| Synthesis | (i-8) | 12-hydroxystearic acid | 20.0 | δ-valerolactone | 13,000 | 10,000 | 30 |
| Example 8 | | | | | | | |
| Synthesis | (i-9) | 12-hydroxystearic acid | 13.2 | ε-caprolactone | 17,000 | 14,000 | 40 |
| Example 9 | | | | | | | |
| Synthesis | (i-10) | 2-naphthoic acid | 3.8 | ε-caprolactone | 27,000 | 22,500 | 80 |
| Example 10 | | | | | | | |
| Synthesis | (i-11) | [2-(2-methoxy- | 15.6 | ε-caprolactone | 8,700 | 6,300 | 15 |
| Example 11 | | ethoxy)ethoxy]acetic | | | | | |
| | | acid | | | | | |
| Synthesis | (i-12) | n-octanoic acid | 16.8 | lactide | 8,100 | 4,100 | 15 |
| Example 12 | | | | | | | |
| Synthesis | (i-13) | n-octanoic acid | 17.31 | L-lactide | 6,900 | 3,500 | 10 (L-lactone |
| Example 13 | | | | ε-caprolactone | | | derived) |
| | | | | | | | 5 (ε- |
| | | | | | | | caprolactone |
| | | | | | | | derives) |
| Synthesis | (i-14) | n-octanoic acid | 17.31 | L-lactide | 6,200 | 3,200 | 5 (L-lactone |
| Example 14 | | | | ε-caprolactone | | | derived) |
| | | | | | | | 10 (ε- |
| | | | | | | | caprolactone |
| | | | | | | | derived) |
| Synthesis | (i-15) | nonafluorovaleric acid | 30.8 | ε-caprolactone | 9,000 | 7,500 | 15 |
| Example 15 | | | | | | | |
| Synthesis | (i-16) | heptadecafluorononanoic | 54.2 | ε-caprolactone | 8,000 | 5,000 | 15 |
| Example 16 | | acid | | | | | |
| Synthesis | (i-17) | 3,5,5-trimethylhexanoic | 18.5 | ε-caprolactone | 10,000 | 5800 | 15 |
| Example 17 | | acid | | | | | |
| Synthesis | (i-18) | 4-oxovaleric acid | 13.6 | ε-caprolactone | 7,400 | 4,100 | 15 |
| Example 18 | | | | | | | |
| Synthesis | (i-19) | [2-(2-methoxy- | 20.8 | ε-caprolactone | 15,300 | 11,500 | 30 |
| Example 19 | | ethoxy)ethoxy]acetic | | | | | |
| | | acid | | | | | |
| Synthesis | (i-20) | benzoic acid | 14.3 | ε-caprolactone | 7,000 | 3,000 | 15 |
| Example 20 | | | | | | | |

### Synthesis Example 21

### Synthesis of Polyethyleneimine Derivative (J-1))

A 5.0 g quantity of polyethyleneimine (SP-018 made by Nippon Shokubai Co., Ltd., number average molecular weight 1,800) and 100 g of polyester (i-1) were mixed and heated for three hours at 110° C., yielding polyethyleneimine derivative (J-1).

The synthesis scheme is indicated below. In the synthesis scheme given below, a, b, and c indicate the respective polymerization molar ratios of repeating units, ranging from 0 to 50, with a+b+c=100. 1, m, n1, and n2 indicate the respective polymerization molar ratios of repeating units. 1 ranges from 10 to 90, m from 0 to 80, n1 and n2 from 0 to 70, with 1+m+n1+n2=100.

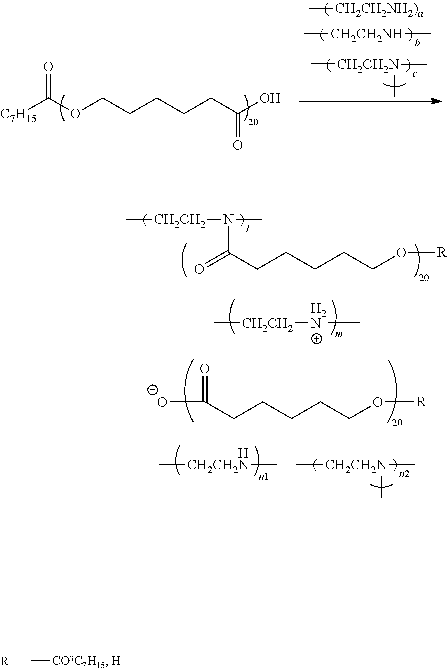

### Synthesis Examples 22 to 43, Comparative Synthesis Examples 1 and 2

### Synthesis of Polyethyleneimine Derivatives (J-2) to (J-23), (k-1), and (k-2))

With the exceptions that the polyethyleneimines indicated in Table 2 and the polyesters obtained in Synthesis Examples 2 to 20 indicated in Table 2 were employed, synthesis was conducted in the same manner as in Synthesis Example 11 and polyethyleneimine derivatives (J-2) to (J-23), (k-1), and (k-2) were obtained.

(Determination of Polyalkyleneimine Chain Ratio)

The proportion in the polyalkyleneimine derivative accounted for by the polyalkyleneimine chain (polyalkyleneimine chain ratio) was calculated from the results of both ¹H-NMR and ¹³C-NMR analysis and the results of elemental analysis by the combustion method in the polyalkyleneimine derivatives obtained. The results are given in Table 2. For each of the polyalkyleneimine derivatives, the calculated polyalkyleneimine chain ratio was identical to or similar to the value calculated from the quantities of polyalkyleneimine and polyester charged.

TABLE 2

| | | | | Polyalkyleneimine | | | | |
|---|---|---|---|---|---|---|---|---|
| | | | | chain | | | | Weight |
| | Polyalkyleneimine | | Amount of | (polyethyleneimine | | Acid | Amine | average |
| | (polyethyleneimine) | Poly- | polyethyleneimine | chain) ratio | | number | value | molecular |
| | derivative | ethyleneimine* | charged (g) | (weight %) | Polyester | (mgKOH/g) | (mgKOH/g) | weight |
| Synthesis | (J-1) | SP-018 | 5.0 | 4.8 | (i-1) | 22.2 | 28.6 | 15,000 |
| Example 21 | | | | | | | | |
| Synthesis | (J-2) | SP-006 | 2.4 | 2.3 | (i-2) | 35.0 | 17.4 | 7,000 |
| Example 22 | | | | | | | | |
| Synthesis | (J-3) | SP-012 | 4.5 | 4.3 | (i-3) | 6.5 | 21.2 | 22,000 |
| Example 23 | | | | | | | | |
| Synthesis | (J-4) | SP-006 | 5.0 | 4.8 | (i-4) | 4.9 | 11.8 | 34,000 |
| Example 24 | | | | | | | | |
| Synthesis | (J-5) | SP-003 | 5.0 | 4.8 | (i-5) | 10.1 | 15.2 | 19,000 |
| Example 25 | | | | | | | | |
| Synthesis | (J-6) | SP-018 | 1.2 | 1.2 | (i-6) | 68.5 | 22.4 | 8,000 |
| Example 26 | | | | | | | | |
| Synthesis | (J-7) | SP-018 | 3.0 | 2.9 | (i-7) | 39.9 | 16.8 | 13,000 |
| Example 27 | | | | | | | | |
| Synthesis | (J-8) | SP-012 | 2.5 | 2.4 | (i-8) | 15.5 | 18.9 | 18,000 |
| Example 28 | | | | | | | | |
| Synthesis | (J-9) | SP-006 | 5.0 | 4.8 | (i-9) | 11.1 | 16.8 | 22,000 |
| Example 29 | | | | | | | | |
| Synthesis | (J-10) | SP-003 | 4.0 | 3.8 | (i-10) | 4.4 | 14.1 | 24,000 |
| Example 30 | | | | | | | | |
| Synthesis | (J-11) | SP-012 | 0.3 | 0.3 | (i-10) | 8.1 | 7.8 | 28,000 |
| Example 31 | | | | | | | | |
| Synthesis | (J-12) | SP-018 | 1.0 | 1.0 | (i-1) | 28.8 | 6.7 | 15,000 |
| Example 32 | | | | | | | | |
| Synthesis | (J-13) | SP-012 | 5.0 | 4.8 | (i-6) | 61.0 | 28.2 | 4,000 |
| Example 33 | | | | | | | | |
| Synthesis | (J-14) | SP-006 | 2.4 | 2.3 | (i-11) | 30.0 | 17.4 | 6,000 |
| Example 34 | | | | | | | | |
| Synthesis | (J-15) | SP-006 | 2.4 | 2.3 | (i-12) | 42.8 | 18.1 | 6,300 |
| Example 35 | | | | | | | | |
| Synthesis | (J-16) | SP-006 | 2.4 | 2.3 | (i-13) | 43.7 | 17.9 | 5,900 |
| Example 36 | | | | | | | | |
| Synthesis | (J-17) | SP-006 | 2.4 | 2.3 | (i-14) | 42.5 | 17.1 | 5,300 |
| Example 37 | | | | | | | | |
| Synthesis | (J-18) | SP-006 | 2.3 | 2.4 | (i-15) | 37.5 | 19.4 | 7,300 |
| Example 38 | | | | | | | | |
| Synthesis | (J-19) | SP-006 | 2.3 | 2.4 | (i-16) | 24.6 | 16.0 | 9,800 |
| Example 39 | | | | | | | | |
| Synthesis | (J-20) | SP-006 | 2.3 | 2.4 | (i-17) | 27.5 | 26.1 | 9,300 |
| Example 40 | | | | | | | | |
| Synthesis | (J-21) | SP-006 | 2.3 | 2.4 | (i-18) | 31.7 | 8.9 | 8,900 |
| Example 41 | | | | | | | | |
| Synthesis | (J-22) | SP-006 | 2.3 | 2.4 | (i-19) | 15.3 | 13.9 | 15,100 |
| Example 42 | | | | | | | | |
| Synthesis | (J-23) | SP-006 | 2.3 | 2.4 | (i-20) | 38.1 | 22.4 | 7,580 |
| Example 43 | | | | | | | | |
| Comparative | (k-1) | SP-200 | 4 | 3.8 | (i-1) | 18.2 | 21.5 | 42,000 |
| Synthesis | | | | | | | | |
| Example 1 | | | | | | | | |
| Comparative | (k-2) | SP-012 | 10 | 9.1 | (i-1) | 21.2 | 28.2 | 9,000 |
| Synthesis | | | | | | | | |
| Example 2 | | | | | | | | |

*Notes)
The polyethyleneimines indicated in Table 2 are as indicated below.
SP-003 (Polyethyleneimine (made by Nippon Shokubai) weight average molecular weight 300)
SP-006 (Polyethyleneimine (made by Nippon Shokubai) weight average molecular weight 600)
SP-012 (Polyethyleneimine (made by Nippon Shokubai) weight average molecular weight 1,200)
SP-018 (Polyethyleneimine (made by Nippon Shokubai) weight average molecular weight 1,800)
SP-200 (Polyethyleneimine (made by Nippon Shokubai) weight average molecular weight 10,000)

### Example 1-1

### (1) Preparation of Magnetic Layer Coating Liquid Containing Ferromagnetic Metal Powder (Coating Composition)

Ferromagnetic metal powder: 100 parts

Composition Fe/Co=100/25

Hc 195 kA/m (2450 Oe)

BET specific surface area 65 m²/g

Surface treatment agents Al₂O₃, SiO₂, Y₂O₃

Average particle size (average major axis length) 45 nm

Average acicular ratio 5

σs 110 A·m²/kg (110 emu/g)

Polyethyleneimine derivative J-1: 8 parts
Polyurethane resin: (Vylon UR4800 made by Toyobo Co., Ltd., functional group: SO₃Na, functional group concentration: 70 eq/t): 5 parts
Vinyl chloride resin (MR104 made by Kaneka): 10 parts
Methyl ethyl ketone: 150 parts
Cyclohexanone: 150 parts
Abrasive: α-Al₂O₃ Mohs hardness 9 (average particle size 0.1 μm): 15 parts
Carbon black (average particle size 0.08 μm): 0.5 part

The various components of the above coating liquid were kneaded in an open kneader and dispersed using a sand mill. The components listed below were admixed to the dispersion obtained, ultrasonically processed, and filtered with a filter having an average pore diameter of 1 jam to prepare a magnetic layer coating liquid.

Butyl stearate: 1.5 parts
Stearic acid: 0.5 parts
Amide stearate: 0.2 part
Methyl ethyl ketone: 50 parts
Cyclohexanone: 50 parts
Toluene: 3 parts
Polyisocyanate compound (made by Nippon Polyurethane Industry Co., Ltd.): 5 parts

### (2) Preparation of Nonmagnetic Layer Coating Liquid

Carbon black: 100 parts

Dibutyl phthalate (DBP) absorption capacity: 100 mL/100 g

pH: 8

BET specific surface area: 250 m²/g

Volatile content: 1.5 percent

Polyurethane resin (Vylon UR4800 made by Toyobo Co., Ltd., functional group: SO₃Na, functional group concentration: 70 eq/t): 20 parts
Vinyl chloride resin (functional group: OSO₃K, functional group concentration: 70 eq/t): 30 parts
Trioctylamine: 4 parts
Cyclohexanone: 140 parts
Methyl ethyl ketone: 170 parts
Butyl stearate: 2 parts
Stearic acid: 2 parts
Amide stearate: 0.1 part

The various components of the above coating liquid were kneaded in an open kneader and dispersed using a sand mill. The components listed below were admixed to the dispersion obtained and the mixture was filtered with a filter having an average pore diameter of 1 μm to prepare a coating liquid for a lower coating layer (nonmagnetic layer).

Butyl stearate: 1.5 parts
Stearic acid: 1 part
Methyl ethyl ketone: 50 parts
Cyclohexanone: 50 parts
Toluene: 3 parts
Polyisocyanate compound (Coronate 3041 made by Nippon Polyurethane Industry Co., Ltd.): 5 parts

### (3) Preparation of Backcoat Layer Coating Liquid

Carbon black (average particle size 40 nm): 85 parts
Carbon black (average particle size 100 nm): 3 parts
Nitrocellulose: 28 parts
Polyurethane resin: 58 parts
Copper phthalocyanine dispersing agent: 2.5 parts
Nipporan 2301 made by Nippon Polyurethane Industry Co., Ltd.: 0.5 part
Methyl isobutyl ketone: 0.3 part
Methyl ethyl ketone: 860 parts
Toluene: 240 parts

The above components were prekneaded in a roll mill and then dispersed in a sand mill. To the mixture were added 4 parts of polyester resin (Vylon 500 made by Toyobo Co., Ltd.), 14 parts of polyisocyanate compound (Coronate 3041 made by Nippon Polyurethane Industry Co., Ltd.), and 5 parts of α-Al₂O₃ (made by Sumitomo Chemical Co., Ltd.), and the mixture was stirred and filtered to prepare a backcoat layer coating liquid.

A corona discharge treatment was applied to both surfaces of a polyethylene naphthalate support (5 μm in thickness, centerline surface roughness of surface on which magnetic layer formed 1 nm).

The above nonmagnetic layer coating liquid was applied in a quantity calculated to yield a dry thickness of 1.0 μm on one surface of the above polyethylene naphthalate support. Immediately thereafter, the magnetic layer was applied to a thickness of 100 nm thereover in a simultaneous multilayer coating. While both layers were still wet, orientation processing was conducted with a cobalt magnet having a magnetic force of 0.5 T (5,000 G) and a solenoid having a magnetic force of 0.4 T (4,000 G). A drying treatment was then conducted.

Subsequently, the above backcoat layer coating liquid was applied in a quantity calculated to yield a dry thickness of 0.5 μm to the other surface of the above polyethylene naphthalate support. Next, processing was conducted with a seven-stage calender comprised of metal rolls at a temperature of 100° C. at a speed of 80 m/min and the product was slit to a width of ½ inch to prepare magnetic tape.

### Examples 1-2 to 1-23 and Comparative Examples 1-4 and 1-5

With the exception that the types of polyethyleneimine derivative shown in Table 3 were employed in the magnetic layer, processing was conducted in the same manner as in Example 1-1 and the magnetic tapes of Examples 1-2 to 1-23 and Comparative Examples 1-4 and 1-5 were prepared.

### Comparative Example 1-1

With the exception that the dispersing agent described in Example 2 of Japanese Unexamined Patent Publication (KOKAI) Heisei No. 5-177123 was employed instead of polyethyleneimine derivative in the magnetic layer, the magnetic tape of Comparative Example 1-1 was prepared in the same manner as in Example 1-1.

### Comparative Example 1-2

With the exception that the dispersing agent described in Example 19 of Japanese Unexamined Patent Publication (KOKAI) Heisei No. 5-177123 was employed instead of polyethyleneimine derivative in the magnetic layer, the magnetic tape of Comparative Example 1-2 was prepared in the same manner as in Example 1-1.

### Comparative Example 1-3

With the exception that the binder described in Example 1-1 of Japanese Unexamined Patent Publication (KOKAI) No. 2011-216149 was employed instead of polyethyleneimine derivative in the magnetic layer, the magnetic tape of Comparative Example 1-3 was prepared in the same manner as in Example 1-1.

### Example 2-1

### Preparation of Coating Liquid for Magnetic Layer Containing Ferromagnetic Hexagonal Ferrite Powder (Coating Composition)

Ferromagnetic platelike hexagonal ferrite powder: 100 parts

Composition excluding oxygen (molar ratio): Ba/Fe/Co/Zn=1/9/0.2/1

He: 160 kA/m (2,000 Oe)

Average particle size (average plate diameter): 20 nm

Average plate ratio: 2.7

BET specific surface area: 60 m²/g

σs: 46 A·m²/kg (46 emu/g)

Polyalkyleneimine derivative J-1: 10 parts
α-Al₂O₃ (average particle size 0.1 μm): 8 parts
Carbon black (average particle size: 20 nm): 0.5 part
Cyclohexanone: 110 parts

The various components of the above coating liquid were kneaded in an open kneader and dispersed using a sand mill. The components listed below were admixed to the dispersion obtained, the mixture was ultrasonically processed, and the mixture was filtered with a filter having an average pore diameter of 1 μm to prepare a magnetic layer coating liquid.

Butyl stearate: 2 parts
Stearic acid: 0.5 part
Methyl ethyl ketone: 50 parts
Cyclohexanone: 50 parts
Toluene: 3 parts
Polyisocyanate compound (Coronate 3041 made by Nippon Polyurethane Industry Co., Ltd.): 5 parts

A magnetic tape was prepared by the same method as in Example 1-1 with the exception that the above coating liquid was employed as the magnetic layer coating liquid.

### Examples 2-2 to 2-23, Comparative Examples 2-4 and 2-5

With the exception that the types of polyethyleneimine derivatives employed in the magnetic layer were changed to those shown in Table 4, the magnetic tapes of Examples 2-2 to 2-23 and Comparative Examples 2-4 and 2-5 were prepared in the same manner as in Example 2-1.

### Comparative Example 2-1

With the exception that the dispersing agent described in Example 2 of Japanese Unexamined Patent Publication (KOKAI) Heisei No. 5-177123 was employed instead of polyethyleneimine derivative in the magnetic layer, the magnetic tape of Comparative Example 2-1 was prepared in the same manner as in Example 2-1.

### Comparative Example 2-2

With the exception that the dispersing agent described in Example 19 of Japanese Unexamined Patent Publication (KOKAI) Heisei No. 5-0177123 was employed instead of polyethyleneimine derivative in the magnetic layer, the magnetic tape of Comparative Example 2-2 was prepared in the same manner as in Example 2-1.

### Comparative Example 2-3

With the exception that the binder described in Example 1-1 of Japanese Unexamined Patent Publication (KOKAI) No. 2011-216149 was employed instead of polyethyleneimine derivative in the magnetic layer, the magnetic tape of Comparative Example 2-3 was prepared in the same manner as in Example 2-1.

[Evaluation Methods]

### <Average Surface Roughness of Tape>

An area 40 μm×40 μm on the surface of the magnetic layer was measured in contact mode with an atomic force microscope (AFM: Nanoscope III made by Digital Instruments), and the centerline average surface roughness (Ra) was measured.

<Magnetic Characteristic: Signal-to-Noise (S/N) Ratio>

A signal was recorded at a recording track width of 11.5 μm, reproduction track width of 5.3 μm, and linear recording densities of 172 kfci and 86 kfci with an LTO-Gen4 (Linear Tape-Open-Generation 4) drive made by IBM. The reproduction signal was frequency analyzed with a spectrum analyzer. The ratio of the output of the carrier signal for 172 kfci signal recording to the integrated noise of the full spectral bandwidth for 86 kfci signal recording was adopted as the S/N ratio. An LTO-Gen4 tape made by Fuji Film was employed as a reference tape. The S/N ratio of each tape was obtained as a relative value when the S/N ratio of the reference tape was adopted as 0.0 dB. An S/N ratio of equal to or higher than 1.0 dB was determined to indicate good dispersion of the ferromagnetic powder of the above average particle size in the magnetic layer (and as a result, that good electromagnetic characteristics had been achieved).

<Running Durability (Scraping of the Magnetic Layer Surface)>

When information is recorded on a magnetic tape and the information that has been recorded is reproduced, the magnetic head normally slides against the surface of the magnetic layer of the magnetic tape. Scrapings from the magnetic layer surface due to this sliding may adhere to the magnetic head, compromising running durability. Accordingly, the running durability of the magnetic tapes was evaluated by the following method.

A magnetic tape was run so that the surface of the magnetic layer came into contact with the edge of a square bar having a cross-section of 7 mm×7 mm that was made of Al₂O₃/TiC at an angle of 150 degrees. A length of 100 m was slid during each pass under conditions of a load of 100 g and a speed of 6 m/s. After the sliding, the edge portion of the square bar was observed under a microscope. The condition of the matter adhering to the edge portion of the square bar during sliding (the magnetic layer surface scraped off by sliding) was evaluated. The evaluation was conducted organoleptically on a ten-step scale. An evaluation of 10 indicated no adhering material, while 1 indicated the most adhering material. An evaluation value of equal to or higher than 8 meant little adhering material (or scraping of the magnetic layer surface) and good running durability.

TABLE 3
Examples and Comparative Examples employing
ferromagnetic metal powder

| | | | | Running |
|---|---|---|---|---|
| | | | | durability |
| | | Dispersibility | | Scraping of |
| | | Surface | S/N | magnetic layer |
| | | property | ratio | surface (Poor) |
| | Additive | Ra(nm) | (dB) | 1-10(good) |
| Example 1-1 | J-1 | 2.8 | 1.0 | 10 |
| Example 1-2 | J-2 | 2.8 | 2.0 | 10 |
| Example 1-3 | J-3 | 2.8 | 1.5 | 9 |
| Example 1-4 | J-4 | 2.8 | 1.0 | 9 |
| Example 1-5 | J-5 | 2.8 | 1.0 | 10 |
| Example 1-6 | J-6 | 2.8 | 2.0 | 10 |
| Example 1-7 | J-7 | 2.8 | 2.0 | 10 |
| Example 1-8 | J-8 | 2.8 | 2.0 | 10 |
| Example 1-9 | J-9 | 2.8 | 1.0 | 10 |
| Example 1-10 | J-10 | 2.8 | 1.0 | 9 |
| Example 1-11 | J-11 | 2.8 | 1.0 | 9 |
| Example 1-12 | J-12 | 2.8 | 1.5 | 9 |
| Example 1-13 | J-13 | 2.8 | 1.5 | 9 |
| Example 1-14 | J-14 | 2.8 | 1.0 | 10 |
| Example 1-15 | J-15 | 2.8 | 1.0 | 10 |
| Example 1-16 | J-16 | 2.8 | 1.0 | 10 |
| Example 1-17 | J-17 | 2.8 | 1.0 | 9 |
| Example 1-18 | J-18 | 2.8 | 1.0 | 10 |
| Example 1-19 | J-19 | 2.8 | 1.0 | 10 |
| Example 1-20 | J-20 | 2.8 | 1.0 | 9 |
| Example 1-21 | J-21 | 2.8 | 1.0 | 9 |
| Example 1-22 | J-22 | 2.8 | 1.0 | 10 |
| Example 1-23 | J-23 | 2.8 | 1.0 | 9 |
| Comparative | Example 2 of | 2.9 | −1.0 | 4 |
| Example 1-1 | Japanese Unexamined | | | |
| | Patent Publication | | | |
| | (KOKAI) Heisei No. | | | |
| | 5-177123 | | | |
| Comparative | Example 19 of | 2.9 | −1.0 | 6 |
| Example 1-2 | Japanese Unexamined | | | |
| | Patent Publication | | | |
| | (KOKAI) Heisei No. | | | |
| | 5-177123 | | | |
| Comparative | Example 1-1 of | 3.0 | 0.0 | 5 |
| Example 1-3 | Japanese Unexamined | | | |
| | Patent Publication | | | |
| | (KOKAI) No. | | | |
| | 2011-216149 | | | |
| Comparative | k-1 | 2.9 | −1.0 | 6 |
| Example 1-4 | | | | |
| Comparative | k-2 | 2.9 | −1.0 | 6 |
| Example 1-5 | | | | |

TABLE 4
Examples and Comparative Examples
employing hexagonal ferrite powder

| | | | | Running |
|---|---|---|---|---|
| | | | | durability |
| | | Dispersibility | | Scraping of |
| | | Surface | S/N | magnetic layer |
| | | property | ratio | surface (Poor) |
| | Additive | Ra(nm) | (dB) | 1-10(good) |
| Example 2-1 | J-1 | 2.8 | 1.0 | 10 |
| Example 2-2 | J-2 | 2.8 | 2.0 | 10 |
| Example 2-3 | J-3 | 2.8 | 1.5 | 9 |
| Example 2-4 | J-4 | 2.8 | 1.0 | 9 |
| Example 2-5 | J-5 | 2.8 | 1.0 | 10 |
| Example 2-6 | J-6 | 2.8 | 2.0 | 10 |
| Example 2-7 | J-7 | 2.8 | 2.0 | 10 |
| Example 2-8 | J-8 | 2.8 | 2.0 | 10 |
| Example 2-9 | J-9 | 2.8 | 1.0 | 10 |
| Example 2-10 | J-10 | 2.8 | 1.0 | 9 |
| Example 2-11 | J-11 | 2.8 | 1.0 | 9 |
| Example 2-12 | J-12 | 2.8 | 1.5 | 9 |
| Example 2-13 | J-13 | 2.8 | 1.5 | 9 |
| Example 2-14 | J-14 | 2.8 | 1.0 | 10 |
| Example 2-15 | J-15 | 2.8 | 1.0 | 10 |
| Example 2-16 | J-16 | 2.8 | 1.0 | 10 |
| Example 2-17 | J-17 | 2.8 | 1.0 | 9 |
| Example 2-18 | J-18 | 2.8 | 1.0 | 10 |
| Example 2-19 | J-19 | 2.8 | 1.0 | 10 |
| Example 2-20 | J-20 | 2.8 | 1.0 | 9 |
| Example 2-21 | J-21 | 2.8 | 1.0 | 9 |
| Example 2-22 | J-22 | 2.8 | 1.0 | 10 |
| Example 2-23 | J-23 | 2.8 | 1.0 | 9 |
| Comparative | Example 2 of | 2.9 | −1.0 | 4 |
| Example 2-1 | Japanese Unexamined | | | |
| | Patent Publication | | | |
| | (KOKAI) Heisei No. | | | |
| | 5-177123 | | | |
| Comparative | Example 19 of | 2.9 | −1.0 | 6 |
| Example 2-2 | Japanese Unexamined | | | |
| | Patent Publication | | | |
| | (KOKAI) Heisei No. | | | |
| | 5-177123 | | | |
| Comparative | Example 1-1 of | 3.0 | 0.0 | 6 |
| Example 2-3 | Japanese Unexamined | | | |
| | Patent Publication | | | |
| | (KOKAI) No. | | | |
| | 2011-216149 | | | |
| Comparative | k-1 | 2.9 | −1.0 | 6 |
| Example 2-4 | | | | |
| Comparative | k-2 | 2.9 | −1.0 | 6 |
| Example 2-5 | | | | |

Based on the results in Tables 3 and 4, Examples employing magnetic layer components in the form of polyalkyleneimine derivatives (polyethyleneimine derivatives) comprising polyester chains and polyalkyleneimine chains with number average molecular weights ranging from 300 to 3,000, with the polyalkyleneimine chain ratio being less than 5.0 weight percent, exhibited better results than Comparative Examples in terms of dispersion indicators in the form of surface property, S/N ratio, or both.

Further, the generation of scrapings during repeated running decreased in the Examples relative to Comparative Examples. Thus, the use of the above polyalkyleneimine derivatives (polyethyleneimine derivatives) was determined to yield magnetic recording media with good running durability.

An aspect of the present invention is useful in the field of manufacturing magnetic recording media for high-density recording, such as backup tapes.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium comprising a magnetic layer comprising ferromagnetic powder and binder on a nonmagnetic support, wherein:
an average particle size of the ferromagnetic powder is equal to or less than 50 nm;
the magnetic layer further comprises a compound; and
the compound comprises at least one polyalkyleneimine chain and at least one polyester chain, with a proportion in the compound accounted for by the polyalkyleneimine chain being less than 5.0 weight percent and a number average molecular weight of the polyalkyleneimine chain ranging from 300 to 3,000.

2. The magnetic recording medium according to claim 1, wherein the polyester chain comprises at least one polyester chain selected from the group consisting of a polyester chain denoted by formula 1 and a polyester chain denoted by formula 2: 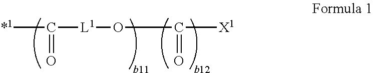
wherein, in formula 1, L¹ denotes a divalent linking group, b11 denotes an integer of equal to or greater than 2, b12 denotes 0 or 1, X¹ denotes a hydrogen atom or a monovalent substituent, and the polyester chain denoted by formula 1 is bonded to a nitrogen atom present in an alkyleneimine chain contained in the polyalkyleneimine chain at a bond position denoted by *¹; 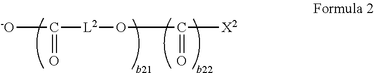
wherein, in formula 2, L² denotes a divalent linking group, b21 denotes an integer of equal to or greater than 2, b22 denotes 0 or 1, X² denotes a hydrogen atom or a monovalent substituent, and an oxygen anion O⁻ in the polyester chain denoted by formula 2 forms a salt crosslinking group with N⁺ present in an alkyleneimine chain contained in the polyalkyleneimine chain.

3. The magnetic recording medium according to claim 2, wherein the polyester chain comprises at least one polyester chain selected from the group consisting of:
the polyester chain denoted by formula 1, wherein X¹ denotes a monovalent substituent selected from the group consisting of an alkyl group, haloalkyl group, alkoxy group, polyalkyleneoxyalkyl group, and aryl group; and
the polyester chain denoted by formula 2, wherein X² denotes a monovalent substituent selected from the group consisting of an alkyl group, haloalkyl group, alkoxy group, and aryl group.

4. The magnetic recording medium according to claim 1, wherein the compound is a reaction product of polyalkyleneimine having a number average molecular weight ranging from 300 to 3,000 and polyester having a number average molecular weight ranging from 200 to 100,000.

5. The magnetic recording medium according to claim 4, wherein the polyalkyleneimine is a polymer of identical or different alkyleneimines having 2 to 4 carbon atoms.

6. The magnetic recording medium according to claim 1, wherein the magnetic layer comprises 0.5 weight part to 50 weight parts of the compound per 100 weight parts of the ferromagnetic powder.

7. The magnetic recording medium according to claim 1, wherein the ferromagnetic powder is hexagonal ferrite powder having an average plate diameter ranging from 10 nm to 50 nm.

8. The magnetic recording medium according to claim 1, wherein the ferromagnetic powder is ferromagnetic metal powder having an average major axis length ranging from 10 nm to 50 nm.

9. A coating composition, which is a coating composition for a magnetic recording medium and comprises:
ferromagnetic powder having an average particle size of equal to or less than 50 nm;
a compound comprising at least one polyalkyleneimine chain and at least one polyester chain, with a proportion in the compound accounted for by the polyalkyleneimine chain being less than 5.0 weight percent and a number average molecular weight of the polyalkyleneimine chain ranging from 300 to 3,000; and
a solvent.

10. The coating composition according to claim 9, wherein the polyester chain comprises at least one polyester chain selected from the group consisting of a polyester chain denoted by formula 1 and a polyester chain denoted by formula 2: 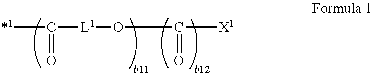
wherein, in formula 1, L¹ denotes a divalent linking group, b11 denotes an integer of equal to or greater than 2, b12 denotes 0 or 1, X¹ denotes a hydrogen atom or a monovalent substituent, and the polyester chain denoted by formula 1 is bonded to a nitrogen atom present in an alkyleneimine chain contained in the polyalkyleneimine chain at a bond position denoted by *¹; 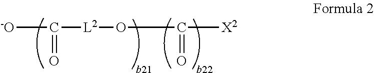
wherein, in formula 2, L² denotes a divalent linking group, b21 denotes an integer of equal to or greater than 2, b22 denotes 0 or 1, X² denotes a hydrogen atom or a monovalent substituent, and an oxygen anion O⁻ in the polyester chain denoted by formula 2 forms a salt crosslinking group with N⁺ present in an alkyleneimine chain contained in the polyalkyleneimine chain.

11. The coating composition according to claim 10, wherein the polyester chain comprises at least one polyester chain selected from the group consisting of:
the polyester chain denoted by formula 1, wherein X¹ denotes a monovalent substituent selected from the group consisting of an alkyl group, haloalkyl group, alkoxy group, polyalkyleneoxyalkyl group, and aryl group; and
the polyester chain denoted by formula 2, wherein X² denotes a monovalent substituent selected from the group consisting of an alkyl group, haloalkyl group, alkoxy group, and aryl group.

12. The coating composition according to claim 9, wherein the compound is a reaction product of polyalkyleneimine having a number average molecular weight ranging from 300 to 3,000 and polyester having a number average molecular weight ranging from 200 to 100,000.

13. The coating composition according to claim 12, wherein the polyalkyleneimine is a polymer of identical or different alkyleneimines having 2 to 4 carbon atoms.

14. The coating composition according to claim 9, which comprises 0.5 weight part to 50 weight parts of the compound per 100 weight parts of the ferromagnetic powder.

15. The coating composition according to claim 9, which further comprises binder.

16. The coating composition according to claim 9, which further comprises a curing agent.

17. The coating composition according to claim 9, wherein the solvent is a ketone solvent.

18. The coating composition according to claim 9, wherein the ferromagnetic powder is hexagonal ferrite powder having an average plate diameter ranging from 10 nm to 50 nm.

19. The coating composition according to claim 9, wherein the ferromagnetic powder is ferromagnetic metal powder having an average major axis length ranging from 10 nm to 50 nm.
